(19) United States
(12) Patent Application Publication
(10) Pub. No.: US 2010/0031364 A1
(43) Pub. Date: Feb. 4, 2010

(54) METHOD FOR CREATING A VERIFIABLE MEDIA OBJECT, A CORRESPONDING SYSTEM THEREOF, AND A VERIFICATION PACKAGE FOR A MEDIA OBJECT

(75) Inventor: Chin Wei CHUA, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd, Singapore (SG)

(21) Appl. No.: 12/185,745

(22) Filed: Aug. 4, 2008

(51) Int. Cl. G06F 1/00

(52) U.S. Cl. 726/26

(57) ABSTRACT

In a first aspect, there is provided a method for creating a verifiable media object using a handheld device that includes a plurality of sensors. In a second aspect, there is provided a system for creating a verifiable media object using a handheld device that includes a plurality of sensors. Finally, in a third aspect, there is provided a verification package for a media object.

### FIELD OF INVENTION

The present invention relates to a field of media objects, primarily in relation to creating a verifiable media object. A corresponding system and a verification package for a media object is also disclosed.

### BACKGROUND

The prevalence of digital media in modern society can be attributed to the ready availability of means to create the digital media as well as an ever growing appetite to consume the digital media by modern society. The popularity of blogger portals, video blogs, video sharing portals, networking portals and so forth is a definitive indication of this growing appetite.

There have been instances when digital media found on blogger portals, video blogs, video sharing portals, networking portals and so forth have been used in an undesirable manner. For example, photographs/videos captured at a first location may be used to represent photographs/videos captured at a second location, and such an act consequently misleads viewers of the digital media.

Such misrepresentation may be detrimental as it may lead to a situation where no one would be able to discern fact from fabrication (either subtle or substantial) in relation to the digital media being viewed. In a worst case scenario, large numbers of people may be misled leading to a fabrication/distortion of fact being acknowledged as fact given the large extent of penetration into a consciousness of a substantial population of people.

In addition, it is also difficult to verify ownership of the digital media as replicating digital media is neither difficult nor tenuous. As such, copyright of the digital media may be easily flouted. This is undesirable as a creator of the digital media may not be duly rewarded in relation to recognition, financial rewards or both the aforementioned.

Thus, it is an objective of the present invention to overcome the aforementioned problems by providing a method and system for creating and verifying media objects.

### SUMMARY

In a first aspect, there is provided a method for creating a verifiable media object using a handheld device that includes a plurality of sensors. The method includes a processor in the handheld device receiving signals from the plurality of sensors when the media object is created, the signals varying in accordance with characteristics relating to creation of the media object using the handheld device. The processor then converts the signals to a verification package for storage on a memory module in the handheld device, with the verification package being associated with the media object. Subsequently, the verification package may be uploaded from the handheld device to a server on a network; and the server may execute a set of instructions to process the verification package and correspondingly present characteristics relating to the creation of the media object. The method may further include categorizing the media objects in accordance to the characteristics relating to creation of the media object.

Advantageously, examples of the aforementioned characteristics may be in a form such as, a combination of latitudinal and longitudinal coordinates, a building name, a street name, a country name, a state name, an island name, a province name, a district name, subject matter of created media object, vantage position of user when creating the media object, date/time when creating the media object, identity of user creating the media object, type of event captured on the media object, identity of device used for creating the media object, any combination of the aforementioned and so forth.

The plurality of sensors may be, for example, GPS receivers, accelerometers, Wi-Fi transceivers, RF transceivers, biometric readers, digital compasses, any combination of the aforementioned and the like. The media object may include, for instance, a photograph, a video recording, an audio recording and so forth.

It is preferable that the presentation of the characteristics may be transmitted from the server using a form of communication like, for example, automated voice message, SMS message, email message, accessing information at an online portal, any combination of the aforementioned and so forth.

It is preferable that the handheld device locks access to the verification package and prevents tampering of the verification package. The verification package may be considered to be a unique marker for the media object. It is advantageous that the verification package includes characteristics like, for example, location where media object was created, subject matter of created media object, vantage position of user when creating the media object, date/time when creating the media object, identity of user creating the media object, type of event captured on the media object, identity of device used for creating the media object, any combination of the aforementioned and so forth.

In a second aspect, there is provided a system for creating a verifiable media object using a handheld device that includes a plurality of sensors. The system includes a processor in the handheld device for receiving signals from the plurality of sensors when the media object is created, the signals varying in accordance with characteristics relating to creation of the media object using the handheld device. The processor may also convert the signals to a verification package for storage on a memory module in the handheld device, with the verification package being associated with the media object. The system may also include a server for receiving the media object and verification package, with the server also being for executing a set of instructions to process the verification package and correspondingly presenting the characteristics relating to creation of the media object. The media objects may be categorized in the server in accordance to the characteristics relating to creation of the media object.

It is preferable that the characteristics may be in a form like, for example, a combination of latitudinal and longitudinal coordinates, a building name, a street name, a country name, a state name, an island name, subject matter of created media object, vantage position of user when creating the media object, date/time when creating the media object, identity of user creating the media object, type of event captured on the media object, identity of device used for creating the media object, any combination of the aforementioned and so forth.

The plurality of sensors in the handheld device may include, for example, GPS receivers, accelerometers, Wi-Fi transceivers, RF transceivers, biometric readers, digital compasses, any combination of the aforementioned and the like. It is advantageous that the handheld device locks access to the verification package and prevents tampering of the verification package. In this regard, the verification package may be deemed to be a unique marker for the media object. The media object may include a photograph, a video recording, an audio recording and the like.

The presentation of the characteristics relating to media objection creation may be transmitted from the server using a form of communication such as, for example, automated voice message, SMS message, email message, accessing information at an online portal, any combination of the aforementioned and so forth.

It is preferable that the verification package includes characteristics such as, for example, location where media object was created, subject matter of created media object, vantage position of user when creating the media object, date/time when creating the media object, identity of user creating the media object, type of event captured on the media object, identity of device used for creating the media object, any combination of the aforementioned and so forth.

In a third aspect, there is provided a verification package for a media object including characteristics like, for example, location where media object was created, subject matter of created media object, vantage position of user when creating the media object, date/time when creating the media object, identity of user creating the media object, type of event captured on the media object, identity of device used for creating the media object, any combination of the aforementioned and so forth. This verification package may be deemed to be a unique marker for the media object.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a process flow for a preferred embodiment of a method of the present invention.

FIG. 2 shows an overview of a preferred embodiment of a system of the present invention.

FIG. 3 shows characteristics included in a verification package for a media object.

FIG. 4 shows a schematic view of components of a handheld device of the present invention.

### DESCRIPTION OF PREFERRED EMBODIMENTS

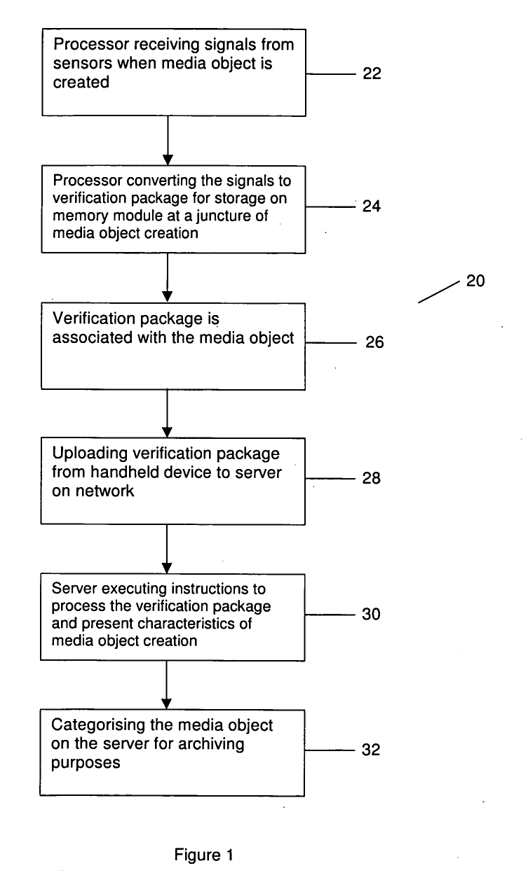

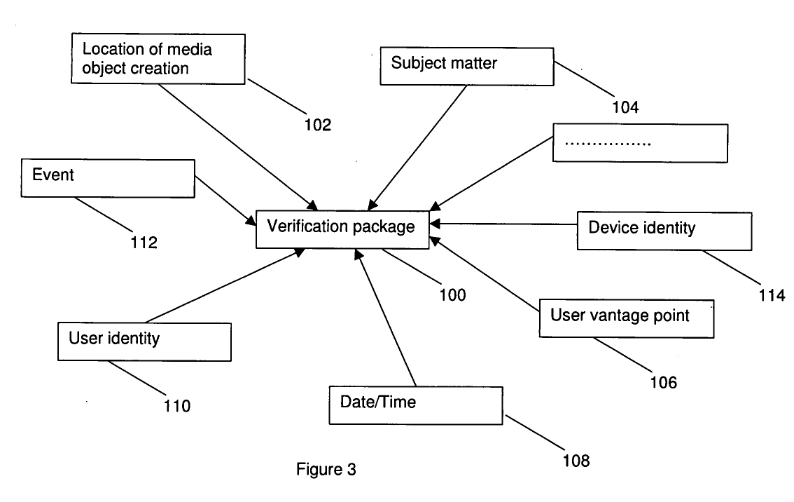

In a first aspect as shown in FIG. 1, there is provided a method 20 for creating a verifiable media object. The media object may be created with a verification package 100 as shown in FIG. 3. In this non-limiting instance, the media object may be created using a handheld device that includes a plurality of sensors for determining various aspects of the handheld device. The various aspects will be described in greater detail in a subsequent portion.

The handheld device may also allow for input for the verification package 100 characteristics like, for example, location where media object was created 102, subject matter 104 of created media object, vantage position of user 106 when creating the media object, date/time 108 when creating the media object, identity of user creating the media object 110, type of event captured on the media object 112, identity of device used for creating the media object 114 and so forth.

The verification package 100 may be an alphanumeric chain of any length, which may be interpreted to reveal all the characteristics in the package 100, the interpretation being for the verification of the media object. It should be noted that the verification package 100 should not be varied in any manner subsequent to the creation of the media object so that a risk of tampering with the individual characteristics is minimized. The verification package 100 may thus be in a form which is un-editable in any manner. Specific portions of the alphanumeric chain may contain content on specific characteristics. In a non-limiting example, a first six spaces on the alphanumeric chain contains content on the type of event captured on the media object 112, subsequent six spaces on the alphanumeric chain contains content on the identity of the user creating the media object, and so forth. It should be noted that the verification package 100 may be in any form other than the alphanumeric chain. The verification package 100 may be deemed to be a unique marker for the media object as duplication of all the characteristics of each package 100 in a plurality of media objects is unlikely.

The plurality of sensors may include, for example, GPS receivers, accelerometers, Wi-Fi transceivers, RF transceivers, biometric readers, digital compasses, or any combination of the aforementioned. When different types of the plurality of sensors are employed, each type of sensor may either operate independently, or operate co-operatively with one another.

The GPS receivers may be used to determine a location of the handheld device and may typically operate optimally when the handheld device is at an outdoors location which is able to receive signals from a plurality of orbiting GPS satellites. The GPS receivers typically are not able to provide accurate readings for the location of the handheld device at an indoors location due to diminished “visibility” of the plurality of GPS satellites by the GPS receivers. It is because of this limitation in relation to the functionality of GPS receivers while indoors that GPS receivers are preferably not the only form of sensors used for determining a location of the handheld device.

Another form of location-determining sensor is a plurality of accelerometers. An embodiment relating to the use of a plurality of accelerometers to determine location is detailed in U.S. Pat. No. 6,618,683. The use of the plurality of accelerometers as detailed in '683 is a possible manner of obtaining the location of the handheld device while in an indoors setting.

Alternatively, use of Wi-Fi transceivers as a location-determining sensor may be desirable for both indoor and outdoor settings. However, the accuracy when using Wi-Fi transceivers is dependent on extent of coverage of Wi-Fi hubs at a particular location. The higher the number of Wi-Fi hubs, the denser the coverage and the higher the accuracy. Typically, a location may be obtained when the Wi-Fi transceiver latches onto a hub, with the location of the hub being the location of the Wi-Fi transceiver and correspondingly, the location of the handheld device. The use of Wi-Fi transceivers for location-determination purposes would not be feasible in areas with few Wi-Fi hubs.

Yet another form of location-determining sensor is a combination of RF transceivers used in conjunction with a plurality of access points. This embodiment is detailed in U.S. Pat. No. 7,038,584. Such a method of location-determination may be desirable for both indoor and outdoor settings, but the accuracy is dependent on a number of access points at a particular location. The higher the number of access points, the higher the accuracy.

It should be noted that the location of the handheld device may be associated with a series of alpha-numerals which forms part of the alphanumeric chain of the verification package 100.

The input of the type of subject matter 104 may be in a form selectable by the user. For instance, the user may define via an interface whether the subject matter is “posed”, “live action capture”, “static scenery”, and so forth at a juncture of creating the media object. The selected subject matter 104 may be associated with a series of alpha-numerals which forms part of the alphanumeric chain of the verification package 100.

The input of the type of event 112 may also be in a form selectable by the user. For instance, the user may define via an interface whether the event is “personal celebration”, “family celebration”, “public festival”, and so forth at a juncture of creating the media object. The type of event 112 may be associated with a series of alpha-numerals which forms part of the alphanumeric chain of the verification package 100.

The vantage position of the user 106 when creating the media object 106 may be obtained using a digital compass of the handheld device. For instance, the handheld device may be directly facing a desired subject, and the digital compass would be able to detect the facing of the handheld device. The vantage position 106 may be associated with a series of alpha-numerals which forms part of the alphanumeric chain of the verification package 100.

An identification of the user 110 may be obtained using a biometric reader of the handheld device. The biometric reader may be in a form of either a retina scanner or a fingerprint scanner. The identification of the user 110 may be associated with a series of alpha-numerals which forms part of the alphanumeric chain of the verification package 100.

A date/time stamp for the media object may be provided in a manner similar to how typical digital cameras apply date/time stamps to photographs and videos created using the digital cameras. A similar manner may be used to input an identification moniker of the handheld device to media objects created using the handheld device.

The method 20 includes a processor in the handheld device receiving signals from the plurality of sensors when the media object is created (22). The media object includes, for example, a photograph, a video recording, an audio recording and so forth. The signals vary in accordance with characteristics relating to creation of the media object using the handheld device. The processor converts the signals to the verification package 100 for storage on a memory module in the handheld device at a juncture when the media object is created using the handheld device (24). The verification package 100 is then subsequently associated with the media object (26). In this regard, the verification package 100 may be in the form of either metadata or incorporated into the media object such that it may be separable from the media object. The handheld device may lock access to the verification package 100 and this correspondingly prevents tampering of the verification package 100. The locking of access to the verification package 100 advantageously aids in confirming an authenticity of the verification package 100.

The verification package 100 is then uploaded from the handheld device to a server on a network (28). The uploading may be performed at either pre-set intervals or only when required. In addition, the verification package 100 may be uploaded either with or without the media object. On receipt of the verification package 100 on the server, the server proceeds to execute a set of instructions to process the verification package 100 and correspondingly presents characteristics relating to creation of the media object (30).

The characteristics relating to the creation of the media object may be in a form such as, for example, a combination of latitudinal and longitudinal coordinates, a building name, a street name, a country name, a state name, an island name, a province name, a district name, subject matter 104 of created media object, vantage position of user 106 when creating the media object, date/time 108 when creating the media object, identity of user creating the media object 110, type of event captured on the media object 112, identity of device used for creating the media object 114 or any combination of the aforementioned. The characteristics may be in a form which allows a user to categorise the media objects in accordance with at least one preferred type of characteristics from the aforementioned list (32) at the server. The categorization of the media objects may be for archiving purposes.

The presentation of the characteristics may be transmitted from the server via, for example, an automated voice message, a SMS message, an email message, accessing information at an online portal, or any combination of the aforementioned. The presentation of the characteristics may be of a form specified by the user.

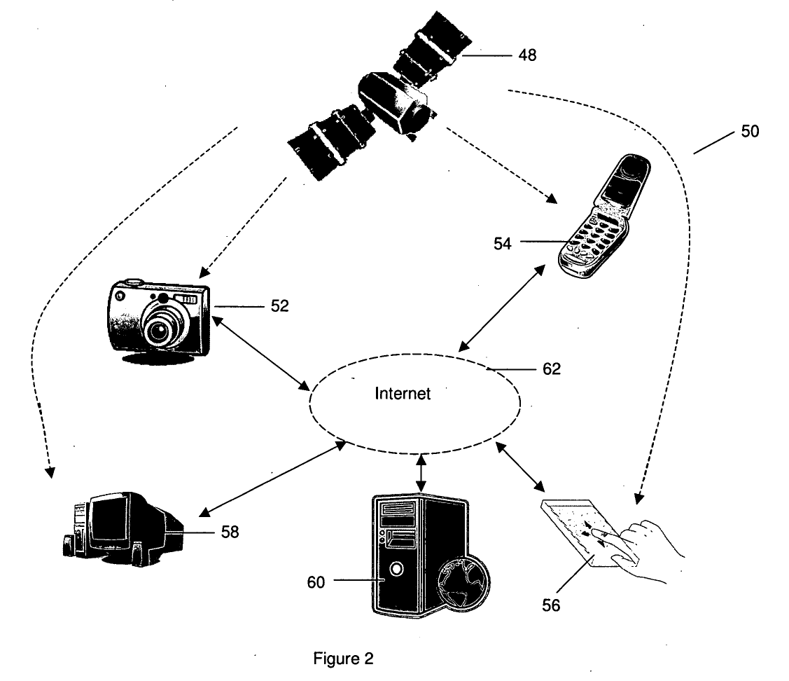

A second aspect is shown in FIG. 2. There is provided a system 50 for providing characteristics relating to media object created using a handheld device (digital camera 52, mobile phone 54, portable media player 56) that includes a plurality of sensors. The plurality of sensors may include, for example, GPS receivers, accelerometers, Wi-Fi transceivers, RF transceivers, biometric readers, digital compasses, or any combination of the aforementioned. When different types of the plurality of sensors are employed, each type of sensor may either operate independently, or operate co-operatively with one another.

The handheld device (52, 54, 56) may also allow for input for the verification package 100 characteristics like, for example, location where media object was created 102, subject matter 104 of created media object, vantage position of user 106 when creating the media object, date/time 108 when creating the media object, identity of user creating the media object 110, type of event captured on the media object 112, identity of device used for creating the media object 114 and so forth.

The verification package 100 may be an alphanumeric chain of any length, which may be interpreted to reveal all the characteristics in the package 100, the interpretation being for the verification of the media object. It should be noted that the verification package 100 should not be varied in any manner subsequent to the creation of the media object so that a risk of tampering with the individual characteristics is minimized. The verification package 100 may thus be in a form which is un-editable in any manner. Specific portions of the alphanumeric chain may contain content on specific characteristics. In a non-limiting example, a first six spaces on the alphanumeric chain contains content on the type of event captured on the media object 112, subsequent six spaces on the alphanumeric chain contains content on the identity of the user creating the media object, and so forth. It should be noted that the verification package 100 may be in any form other than the alphanumeric chain. The verification package 100 may be deemed to be a unique marker for the media object as duplication of all the characteristics of each package 100 in a plurality of media objects is unlikely.

The GPS receivers typically operate optimally when the handheld device (52, 54, 56) is at an outdoors location which is able to receive signals from a plurality of orbiting GPS satellites 48. The GPS receivers typically are not able to provide accurate readings for the location of the handheld device (52, 54, 56) at an indoors location due to diminished “visibility” of the plurality of GPS satellites 48 by the GPS receivers. It is because of this limitation in relation to the functionality of GPS receivers while indoors that GPS receivers are preferably not the only form of sensors used for determining a location of the handheld device (52, 54, 56).

Another form of location-determining sensor is a plurality of accelerometers. An embodiment relating to the use of a plurality of accelerometers to determine location is detailed in U.S. Pat. No. 6,618,683. The use of the plurality of accelerometers as detailed in '683 is a possible manner of obtaining the location of the handheld device (52, 54, 56) while in an indoors setting.

Alternatively, use of Wi-Fi transceivers as a location-determining sensor may be desirable for both indoor and outdoor settings. However, the accuracy when using Wi-Fi transceivers is dependent on extent of coverage of Wi-Fi hubs at a particular location. The higher the number of Wi-Fi hubs, the denser the coverage and the higher the accuracy. Typically, a location may be obtained when the Wi-Fi transceiver latches onto a hub, with the location of the hub being the location of the Wi-Fi transceiver and correspondingly, the location of the handheld device (52, 54, 56). The use of Wi-Fi transceivers for location-determination purposes would not be feasible in areas with few Wi-Fi hubs.

Yet another form of location-determining sensor is a combination of RF transceivers used in conjunction with a plurality of access points. This embodiment is detailed in U.S. Pat. No. 7,038,584. Such a method of location-determination may be desirable for both indoor and outdoor settings, but the accuracy is dependent on a number of access points at a particular location. The higher the number of access points, the higher the accuracy.

The input of the type of subject matter 104 may be in a form selectable by the user. For instance, the user may define via an interface whether the subject matter is “posed”, “live action capture”, “static scenery”, and so forth at a juncture of creating the media object. The selected subject matter 104 may be associated with a series of alpha-numerals which forms part of the alphanumeric chain of the verification package 100.

The input of the type of event 112 may also be in a form selectable by the user. For instance, the user may define via an interface whether the event is “personal celebration”, “family celebration”, “public festival”, and so forth at a juncture of creating the media object. The type of event 112 may be associated with a series of alpha-numerals which forms part of the alphanumeric chain of the verification package 100.

The vantage position of the user 106 when creating the media object 106 may be obtained using a digital compass of the handheld device. For instance, the handheld device may be directly facing a desired subject, and the digital compass would be able to detect the facing of the handheld device. The vantage position 106 may be associated with a series of alpha-numerals which forms part of the alphanumeric chain of the verification package 100.

An identification of the user 110 may be obtained using a biometric reader of the handheld device. The biometric reader may be in a form of either a retina scanner or a fingerprint scanner. The identification of the user 110 may be associated with a series of alpha-numerals which forms part of the alphanumeric chain of the verification package 100.

A date/time stamp for the media object may be provided in a manner similar to how typical digital cameras apply date/time stamps to photographs and videos created using the digital cameras. A similar manner may be used to input an identification moniker of the handheld device to media objects created using the handheld device.

The system 50 includes a processor in each handheld device (52, 54, 56) for receiving signals from the plurality of sensors when the media object is created. The media object includes, for example, a photograph, a video recording, an audio recording and so forth. The signals vary in accordance with the characteristics of the media object created using the handheld device (52, 54, 56). In FIG. 2, handheld device 52 is shown to be a camera, handheld device 54 is shown to be a mobile phone while handheld device 56 is shown to be a media playback device. It should be noted that a type of the handheld device is not limited to the aforementioned types. A personal computer 58 is also shown in FIG. 2 for the sake of completeness. The personal computer 58 may also be used to create a media object when a camera and/or a microphone are functionally attached to the personal computer 58.

The processor converts the signals to the verification package 100 for storage on a memory module in the handheld device (52, 54, 56) at a juncture when the media object is created using the handheld device (52, 54, 56). The verification package 100 is then subsequently associated with the media object. In this regard, the verification package 100 may be in the form of either metadata or incorporated into the media object such that it may be separable from the media object. The handheld device (52, 54, 56) may lock access to the verification package 100 and this correspondingly prevents tampering of the verification package 100. The verification package 100 may be in a form which is un-editable in any manner. The locking of access to the verification package 100 advantageously aids in confirming an authenticity of the verification package 100.

The system 50 may include a server 60 connected to the internet 62 for receiving media object and the verification package 100. Uploading of the media object and the verification package 100 may be performed at either pre-set intervals or only when required. When the server 60 receives the media object with the verification package 100 on the server 60, the server 60 subsequently proceeds to execute a set of instructions to process the verification package 100 and correspondingly present characteristics relating to creation of the media object.

The characteristics relating to the creation of the media object may be in a form such as, for example, a combination of latitudinal and longitudinal coordinates, a building name, a street name, a country name, a state name, an island name, a province name, a district name, subject matter 104 of created media object, vantage position of user 106 when creating the media object, date/time 108 when creating the media object, identity of user creating the media object 110, type of event captured on the media object 112, identity of device used for creating the media object 114 or any combination of the aforementioned. The characteristics may be in a form which allows a user to categorise the media objects in accordance with at least one preferred type of characteristics from the aforementioned list at the server. The categorization of the media objects may be for archiving purposes.

The presentation of the characteristics may be transmitted from the server 60 via, for example, an automated voice message, a SMS message, an email message, accessing information at an online portal, or any combination of the aforementioned. The presentation of the characteristics may be of a form specified by the user.

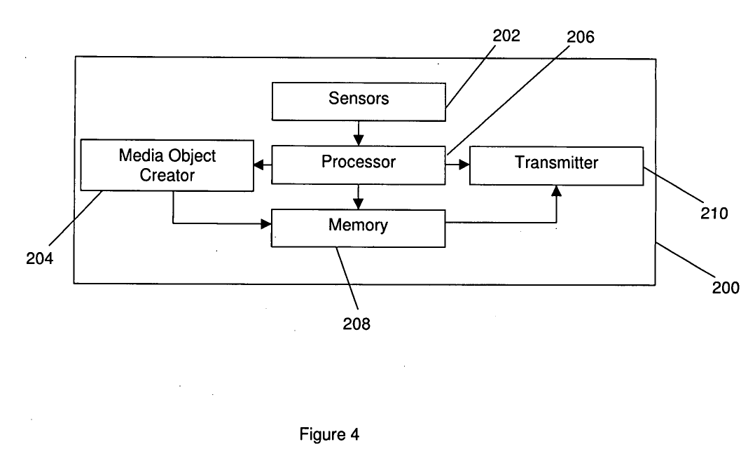

Referring to FIG. 4, there is shown a schematic view of essential components of the handheld device 200 like the digital camera 52, mobile phone 54, and portable media player 56 of FIG. 2. The handheld device 200 includes a plurality of sensors 202 which generates signals which are processed by a processor 206 to form the verification package 100. The verification package 100 may include characteristics relating to creation of a media object using the handheld device. The verification package 100 may be stored on a memory module 208 in the handheld device, with the verification package 100 being associated with the media object being created.

The media object may include, for example, a photograph, a video recording or an audio recording. The plurality of sensors 202 may include, for example, GPS receivers, accelerometers, Wi-Fi transceivers, RF transceivers, biometric readers, digital compasses, or any combination of the aforementioned. When different types of the plurality of sensors are employed, each type of sensor may either operate independently, or operate co-operatively with one another.

The characteristics relating to creation of the media object include, for example, a combination of latitudinal and longitudinal coordinates, a building name, a street name, a country name, a state name, an island name, a province name, a district name, subject matter of created media object, vantage position of user when creating the media object, date/time when creating the media object, identity of user creating the media object, type of event captured on the media object, identity of device used for creating the media object, any combination of the aforementioned and so forth.

The media object may be generated by a media object creator 204. The media object creator may be controlled by the processor 206, and the media object may be stored in the memory module 208. The media object creator 204 may be, for example, a video camera, a digital image camera, a sound recorder, and so forth.

The processor 206 may also control a transmitter 210 which may be for transmitting the verification package 100 from the memory module 208 to the server 60. Subsequently, the server 60 may execute a set of instructions to process the verification package 100 and present characteristics relating to the creation of the media object. The characteristics may aid in verifying the aspects of the media object in relation to its creation.

Whilst there has been described in the foregoing description preferred embodiments of the present invention, it will be understood by those skilled in the technology concerned that many variations or modifications in details of design or construction may be made without departing from the present invention.

1. A method for creating a verifiable media object using a handheld device that includes a plurality of sensors, the method including:
a processor in the handheld device receiving signals from the plurality of sensors when the media object is created, the signals varying in accordance with characteristics relating to creation of the media object using the handheld device;
the processor converting the signals to a verification package for storage on a memory module in the handheld device, with the verification package being associated with the media object;
uploading the verification package from the handheld device to a server on a network; and
the server executing a set of instructions to process the verification package and correspondingly presenting characteristics relating to the creation of the media object.

2. The method of claim 1, wherein the characteristics is in a form selected from the group consisting of: a combination of latitudinal and longitudinal coordinates, a building name, a street name, a country name, a state name, an island name, a province name, a district name, subject matter of created media object, vantage position of user when creating the media object, date/time when creating the media object, identity of user creating the media object, type of event captured on the media object, identity of device used for creating the media object and any combination of the aforementioned.

3. The method of claim 1, wherein the plurality of sensors is selected from the group consisting of: GPS receivers, accelerometers, Wi-Fi transceivers, RF transceivers, biometric readers, digital compasses and any combination of the aforementioned.

4. The method of claim 1, wherein the media object is selected from the group consisting of: a photograph, a video recording and an audio recording.

5. The method of claim 1, wherein the presentation of the characteristics is transmitted from the server using a form of communication selected from the group selected from: automated voice message, SMS message, email message, accessing information at an online portal, and any combination of the aforementioned.

6. The method of claim 1, wherein the handheld device locks access to the verification package and prevents tampering of the verification package.

7. The method of claim 1, further including categorizing the media objects in accordance to the characteristics relating to creation of the media object.

8. The method of claim 1, wherein the verification package includes characteristics selected from the group consisting of: location where media object was created, subject matter of created media object, vantage position of user when creating the media object, date/time when creating the media object, identity of user creating the media object, type of event captured on the media object, identity of device used for creating the media object and any combination of the aforementioned.

9. The method of claim 1, wherein the verification package is a unique marker for the media object.

10. A system for creating a verifiable media object using a handheld device that includes a plurality of sensors, the system including:
a processor in the handheld device for receiving signals from the plurality of sensors when the media object is created, the signals varying in accordance with characteristics relating to creation of the media object using the handheld device, the processor also for converting the signals to a verification package for storage on a memory module in the handheld device, with the verification package being associated with the media object; and
a server for receiving the media object and verification package, the server also for executing a set of instructions to process the verification package and correspondingly presenting the characteristics relating to creation of the media object.

11. The system of claim 10, wherein the characteristics is in a form selected from the group consisting of: a combination of latitudinal and longitudinal coordinates, a building name, a street name, a country name, a state name, an island name, subject matter of created media object, vantage position of user when creating the media object, date/time when creating the media object, identity of user creating the media object, type of event captured on the media object, identity of device used for creating the media object, and any combination of the aforementioned.

12. The system of claim 10, wherein the plurality of sensors is selected from the group consisting of: GPS receivers, accelerometers, Wi-Fi transceivers, RF transceivers, biometric readers, digital compasses, and any combination of the aforementioned.

13. The system of claim 10, wherein the media object is selected from the group consisting of: a photograph, a video recording and an audio recording.

14. The system of claim 10, wherein the presentation of the characteristics is transmitted from the server using a form of communication selected from the group selected from: automated voice message, SMS message, email message, accessing information at an online portal, and any combination of the aforementioned.

15. The system of claim 10, wherein the handheld device locks access to the verification package and prevents tampering of the verification package.

16. The system of claim 10, wherein the media objects are categorized in the server in accordance to the characteristics relating to creation of the media object.

17. The system of claim 10, wherein the verification package includes characteristics selected from the group consisting of: location where media object was created, subject matter of created media object, vantage position of user when creating the media object, date/time when creating the media object, identity of user creating the media object, type of event captured on the media object, identity of device used for creating the media object and any combination of the aforementioned.

18. The system of claim 10, wherein the verification package is a unique marker for the media object.

19. A verification package for a media object including characteristics selected from the group consisting of: location where media object was created, subject matter of created media object, vantage position of user when creating the media object, date/time when creating the media object, identity of user creating the media object, type of event captured on the media object, identity of device used for creating the media object and any combination of the aforementioned.

20. The verification package of claim 19, wherein the verification package is a unique marker for the media object.
